(19) United States
(12) Patent Application Publication
(10) Pub. No.: US 2026/0017256 A1
(43) Pub. Date: Jan. 15, 2026

(54) ELECTRONIC DEVICE, AND QUESTION AND ANSWER PROVISION METHOD OF ELECTRONIC DEVICE

(71) Applicant: Samsung Electronics Co., Ltd., Suwon-si (KR)

(72) Inventors: Sangmin PARK, Suwon-si (KR); Gajin SONG, Suwon-si (KR); Kyungtae KIM, Suwon-si (KR)

(21) Appl. No.: 19/332,775

(22) Filed: Sep. 18, 2025

Related U.S. Application Data
(63) Continuation of application No. PCT/KR2024/002868, filed on Mar. 6, 2024.

(30) Foreign Application Priority Data
Mar. 20, 2023 (KR) 10-2023-0036095
Apr. 25, 2023 (KR) 10-2023-0054309

(51) Int. Cl. G06F 16/2452

(52) U.S. Cl. CPC G06F 16/24522

(57) ABSTRACT

An electronic device is provided. The electronic device includes memory storing instructions, and at least one processor communicatively coupled to the memory. The instructions, when executed by the at least one processor individually or collectively, cause the electronic device to acquire input data including a plurality of content items, determine a type of each of the plurality of content items included in the acquired input data, index the plurality of content items of each type, generate a candidate query corresponding to the plurality of content items, select, from among the plurality of content items, at least one content item corresponding to the candidate query, match the candidate query and the candidate answer with each other, and store the matched candidate query and candidate answer.

### CROSS-REFERENCE TO RELATED APPLICATION(S)

This application is a continuation application, claiming priority under 35 U.S.C. § 365 (c), of an International application No. PCT/KR2024/002868, filed on Mar. 6, 2024, which is based on and claims the benefit of a Korean patent application number 10-2023-0036095, filed on Mar. 20, 2023, in the Korean Intellectual Property Office, and of a Korean patent application number 10-2023-0054309, filed on Apr. 25, 2023, in the Korean Intellectual Property Office, the disclosure of each of which is incorporated by reference herein in its entirety.

### BACKGROUND

### 1. Field

The disclosure relates to an electronic device. More particularly, the disclosure relates to a question-and-answer providing method of the electronic device that is capable of extracting and providing an answer to a user query from input data.

### 2. Description of Related Art

With the commercialization of voice assistant technologies that provide various services based on a user's voice input, electronic devices such as mobile terminals have been equipped with voice assistant functions. An electronic device may provide a voice assistant function, based on an embedded engine or an external server engine. The voice assistant of the electronic device (or of the external server) may employ artificial intelligence (AI) technology to automatically recognize various types of input data, such as text, images, and videos, and may provide intelligent services that supply information associated with the input data or provide relevant services in response to a user's request.

Open Domain QA, which is an example of an intelligent service provided by a voice assistant, is a function of processing user queries across a wide range of topics and may provide answers matching the user queries by retrieving information from an internal DB or the Internet. Device QA may be a function of retrieving information from a reference, such as a manual, to answer queries related to a specific device. Device QA may provide an answer to a user query by using machine reading comprehension (MRC).

The above information is presented as background information only to assist with an understanding of the disclosure. No determination has been made, and no assertion is made, as to whether any of the above might be applicable as prior art with regard to the disclosure.

### SUMMARY

The QA provided by a voice assistant may provide an answer in text form, based on the text information of input data. For example, when the voice assistant crawls a portable document format (PDF) file as the input data, the voice assistant may extract only text that can be processed by a natural language processing engine. In other words, even when the input data is multi-modal data including various types of content such as images, videos, and tables, the output of the voice assistant may only be provided in text.

Aspects of the disclosure are to address at least the above-mentioned problems and/or disadvantages and to provide at least the advantages described below. Accordingly, an aspect of the disclosure is to provide an electronic device and method for providing an electronic device that is capable of extracting and providing an answer to a user query from input data.

Additional aspects will be set forth in part in the description which follows and, in part, will be apparent from the description, or may be learned by practice of the presented embodiments.

In accordance with an aspect of the disclosure, an electronic device is provided. The electronic device includes memory storing instructions, and at least one processor communicatively coupled to the memory. The instructions, when executed by at least one processor individually or collectively, cause the electronic device to acquire input data including a plurality of content items, determine a type of each of the plurality of content items included in the acquired input data, index the plurality of content items of each type, generate a candidate query corresponding to the plurality of content items, select, from among the plurality of content items, at least one content item corresponding to the candidate query, determine the selected at least one content item as a candidate answer, match the candidate query and the candidate answer with each other, and store the matched candidate query and candidate answer.

In accordance with another aspect of the disclosure, a method for providing question-and-answer performed by an electronic device is provided. The method includes acquiring input data including a plurality of content items, determining a type of each of the plurality of content items included in the acquired input data, indexing the plurality of content items of each type, generating a candidate query corresponding to the plurality of content items, selecting at least one content item corresponding to the candidate query from among the plurality of content items, determining the selected at least one content item as a candidate answer, matching the candidate query and the candidate answer with each other, and storing the matched candidate query and candidate answer.

In accordance with yet another aspect of the disclosure, one or more non-transitory computer-readable storage media storing one or more computer programs including computer-executable instructions that, when executed by at least one processor of an electronic device individually or collectively, cause the electronic device to perform operations, is provided. The operations include acquiring input data including a plurality of content items, determining a type of each of the plurality of content items included in the acquired input data, indexing the plurality of content items of each type, generating a candidate query corresponding to the plurality of content items, selecting at least one content item corresponding to the candidate query from among the plurality of content items, determining the selected at least one content item as a candidate answer, matching the candidate query and the candidate answer with each other, and storing the matched candidate query and candidate answer.

An electronic device and a question-and-answer providing method of the electronic device according to various embodiments of the disclosure may generate a query format capable of supporting data distributed in various forms of modalities, and may provide an answer to a user query not only in text form but also in various modalities, such as images and videos.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram illustrating an integrated intelligence system according to an embodiment of the disclosure;

FIG. 3 illustrates a form in which relationship information between concepts and actions is stored in a database according to an embodiment of the disclosure;

FIG. 4 illustrates one page of input data according to an embodiment of the disclosure;

FIG. 5 is a block diagram of an electronic device according to an embodiment of the disclosure;

FIG. 6 is a software block diagram for QA processing of an electronic device according to an embodiment of the disclosure;

FIGS. 7A and 7B illustrate a question-and-answer providing method of an electronic device according to various embodiments of the disclosure;

FIGS. 8A and 8B illustrate a question-and-answer providing method of an electronic device according to various embodiments of the disclosure;

FIGS. 9A and 9B illustrate a question and answer providing method of an electronic device according to various embodiments of the disclosure; and

FIGS. 10A, 10B, and 10C illustrate a question and answer providing method of an electronic device according to various embodiments of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

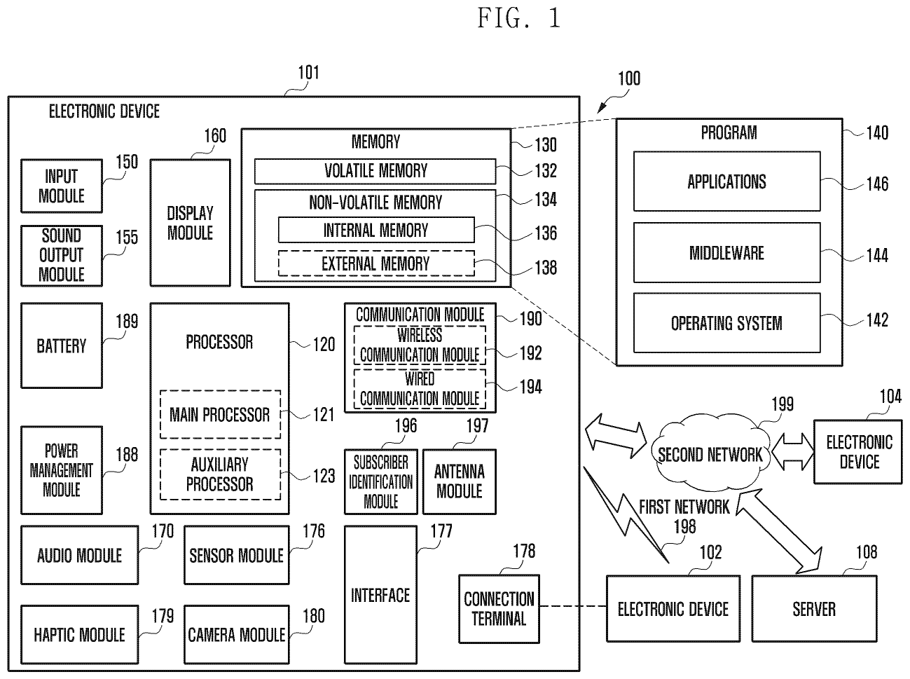

FIG. 1 is a block diagram illustrating an electronic device in a network environment according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

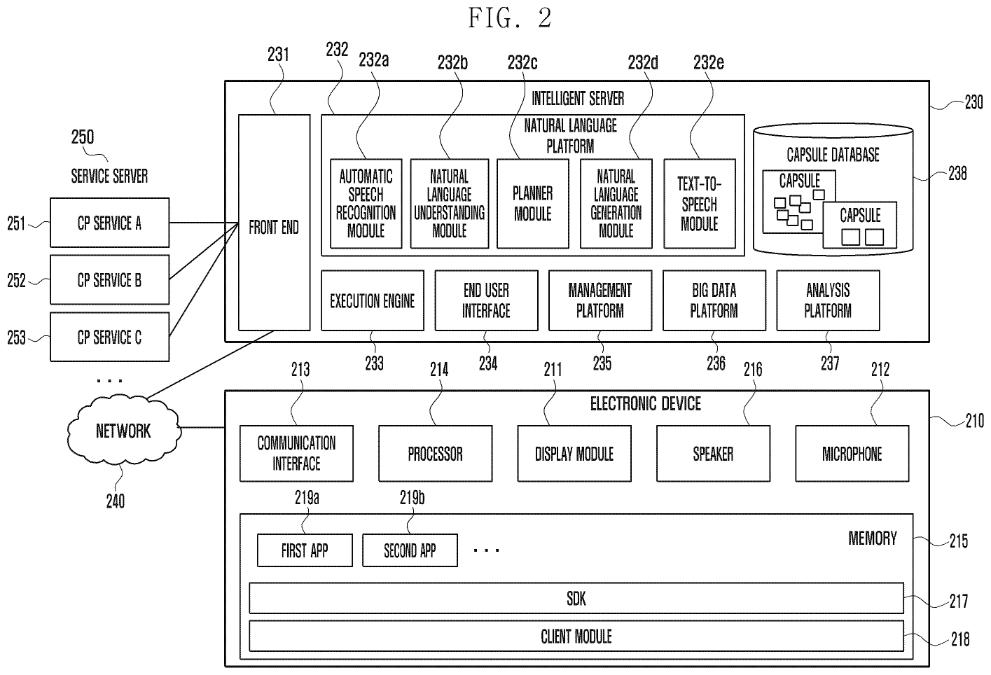

FIG. 2 is a block diagram illustrating an integrated intelligence system according to an embodiment of the disclosure.

Referring to FIG. 2, according to an embodiment, the integrated intelligence system may include an electronic device 210 (e.g., the electronic device 101 of FIG. 1), an intelligent server 230 (e.g., the server 108 of FIG. 1), and a service server 250 (e.g., the server 108 of FIG. 1).

According to an embodiment, the electronic device 210 may be a terminal device (or electronic device) capable of being connected to the Internet, for example, a mobile phone, a smartphone, a personal digital assistant (PDA), a notebook computer, a TV, white goods, a wearable device, an HMD, or a smart speaker.

According to the illustrated embodiment, the electronic device 210 may include a communication interface 213 (e.g., the interface 177 of FIG. 1), a microphone 212 (e.g., the input module 150 of FIG. 1), a speaker 216 (e.g., the sound output module 155 of FIG. 1), a display module 211 (e.g., the display module 160 of FIG. 1), memory 215 (e.g., the memory 130 of FIG. 1), or a processor 214 (e.g., the processor 120 of FIG. 1). The above-listed components may be operatively or electrically connected to each other. The electronic device 210 may include at least a portion of the configuration and/or functions of the electronic device 101 of FIG. 1.

According to an embodiment, the communication interface 213 may be configured to connect to an external device to transmit and receive data. According to an embodiment, the microphone 212 may receive sound (e.g., user utterance) and convert the same into an electrical signal. According to an embodiment, the speaker 216 may output the electrical signal into sound (e.g., voice).

According to an embodiment, the display module 211 may be configured to display an image or a video. According to an embodiment, the display module 211 may also display a graphical user interface (GUI) of an app (or application program) currently being executed. The display module 211 of an embodiment may receive a touch input through a touch sensor. For example, the display module 211 may receive a text input through a touch sensor of an on-screen keyboard area displayed on the display module 211.

According to an embodiment, the memory 215 may store a client module 218, a software development kit (SDK) 217, and a plurality of apps 219a and 219b. The client module 218 and the SDK 217 may configure a framework (or, solution program) for performing general-purpose functions. In addition, the client module 218 or the SDK 217 may configure a framework for processing user input (e.g., voice input, text input, touch input).

According to an embodiment, the plurality of apps 219a and 219b stored in the memory 215 may be programs for performing a designated function. According to an embodiment, the plurality of apps may include a first app 219a and a second app 219b. According to an embodiment, each of the plurality of apps 219a and 219b may include a plurality of actions for performing a designated function. For example, the apps 219a and 219b may include an alarm app, a message app, and/or a schedule app. According to an embodiment, the plurality of apps 219a and 219b may be executed by the processor 214 to sequentially execute at least some of the plurality of actions.

According to an embodiment, the processor 214 may control the overall operation of the electronic device 210. For example, the processor 214 may be electrically connected to the communication interface 213, the microphone 212, the speaker 216, and the display module 211 to perform a designated operation.

According to an embodiment, the processor 214 may also execute a program stored in the memory 215 to perform a designated function. For example, the processor 214 may execute at least one of the client module 218 or the SDK 217 to perform the following operations for processing user input. The processor 214 may control the operations of the plurality of apps 219a and 219b through, for example, the SDK 217. The following operations described as operations of the client module 218 or the SDK 217 may be operations executed by the processor 214.

According to an embodiment, the client module 218 may receive a user input. For example, the client module 218 may receive a voice signal corresponding to a user utterance detected through the microphone 212. Alternatively, the client module 218 may receive a touch input detected through the display module 211. Alternatively, the client module 218 may receive a text input detected through a keyboard or on-screen keyboard. In addition, the client module 218 may receive various forms of user input detected through an input module included in the electronic device 210 or an input module connected to the electronic device 210. The client module 218 may transmit the received user input to the intelligent server 230. The client module 218 may transmit status information of the electronic device 210 together with the received user input to the intelligent server 230. The status information may be, for example, execution status information of an app.

According to an embodiment, the client module 218 may receive a result corresponding to the received user input. For example, when the intelligent server 230 is able to obtain a result corresponding to the received user input, the client module 218 may receive the result corresponding to the received user input. The client module 218 may display the received result on the display module 211. Additionally, the client module 218 may output the received result as audio through the speaker 216.

According to an embodiment, the client module 218 may receive a plan corresponding to the received user input. The client module 218 may display, on the display module 211, the results obtained by executing a plurality of actions of the app according to the plan. For example, the client module 218 may sequentially display the results obtained by executing a plurality of actions on the display module 211 and output audio through the speaker 216. The electronic device 210 may, in another example, display only a portion of the results obtained by executing a plurality of actions (e.g., a result of a last action) on the display module 211, and output audio through the speaker 216.

According to an embodiment, the client module 218 may receive, from the intelligent server 230, a request for acquiring information necessary to obtain a result corresponding to the voice input. According to an embodiment, the client module 218 may, in response to the request, transmit the necessary information to the intelligent server 230.

According to an embodiment, the client module 218 may transmit result information obtained by executing a plurality of actions according to the plan to the intelligent server 230. The intelligent server 230 may use the result information to identify that the received user input has been processed correctly.

According to an embodiment, the client module 218 may include a speech recognition module. According to an embodiment, the client module 218 may recognize voice input of performing limited functions through the speech recognition module. For example, the client module 218 may perform an intelligent app to process voice input for performing organic actions through a designated input (e.g., wake up!).

According to an embodiment, the intelligent server 230 may receive information related to a user voice input from the electronic device 210 through a communication network. According to an embodiment, the intelligent server 230 may change data related to the received voice input into text data. According to an embodiment, the intelligent server 230 may generate a plan for performing a task corresponding to the user voice input based on the text data.

According to an embodiment, the plan may be generated by an artificial intelligence (AI) system. The AI system may be a rule-based system, or may be a neural network-based system (e.g., a feedforward neural network (FNN) or a recurrent neural network (RNN)). Alternatively, the AI system may be a combination of the foregoing, or another AI system different from the foregoing. According to an embodiment, the plan may be selected from a set of predefined plans, or may be generated in real time in response to a user request. For example, the AI system may select at least one plan from a plurality of predefined plans.

According to an embodiment, the intelligent server 230 may transmit the result according to the generated plan to the electronic device 210, or transmit the generated plan to the electronic device 210. According to an embodiment, the electronic device 210 may display the result according to the plan on the display module 211. According to an embodiment, the electronic device 210 may display the result obtained by executing the operation according to the plan on the display module 211.

According to an embodiment, the intelligent server 230 may include a front end 231, a natural language platform 232, a capsule DB 238, an execution engine 233, an end user interface 234, a management platform 235, a big data platform 236, or an analysis platform 237.

According to an embodiment, the front end 231 may receive a user input from the electronic device 210. The front end 231 may transmit an answer corresponding to the user input.

According to an embodiment, the natural language platform 232 may include an automatic speech recognition module (ASR module) 232a, a natural language understanding module (NLU module) 232b, a planner module 232c, a natural language generator module (NLG module) 232d, or a text-to-speech module (TTS module) 232e.

According to an embodiment, the automatic speech recognition module 232a may convert voice input received from the electronic device 210 into text data. According to an embodiment, the natural language understanding module 232b may identify a user's intent by using the text data of the voice input. For example, the natural language understanding module 232b may identify the user's intent by performing syntactic analysis or semantic analysis on the user input in the form of text data. According to an embodiment, the natural language understanding module 232b may identify the meaning of a word extracted from the voice input by using linguistic features (e.g., grammatical elements) of morphemes or phrases, and may determine the user's intent by matching the meaning of the identified word to the intention. The natural language understanding module 223b may obtain intent information corresponding to the user utterance. The intent information may be information indicating the user's intent determined by interpreting the text data. The intent information may include information indicating an operation or a function that the user intends to perform by using a device.

According to an embodiment, the planner module 232c may generate a plan using the intent and parameters determined by the natural language understanding module 232b. According to an embodiment, the planner module 232c may determine a plurality of domains required for performing a task based on the determined intent. The planner module 232c may determine a plurality of actions included in each of the plurality of domains determined based on the intent. According to an embodiment, the planner module 232c may determine parameters required for performing the determined plurality of actions, or result values output by performing of the plurality of actions. The parameters and the result values may be defined as concepts of a designated format (or class). Accordingly, the plan may include a plurality of actions and a plurality of concepts determined by the user's intent. The planner module 232c may determine relationships between the plurality of actions and the plurality of concepts in a stepwise (or hierarchical) manner. For example, the planner module 232c may determine, based on a plurality of concepts, an execution order of a plurality of actions determined based on the user's intent. In other words, the planner module 232c may determine the execution order of a plurality of actions, based on parameters required for the execution of the plurality of actions and results output by the execution of the plurality of actions. Accordingly, the planner module 232c may generate a plan including association information (e.g., ontology) between the plurality of actions and the plurality of concepts. The planner module 232c may generate the plan by using information stored in a capsule database storing a set of relationships between concepts and actions.

According to an embodiment, the natural language generation module 232d may change the designated information into text form. The information changed into text form may be in the form of natural language utterance. According to an embodiment, the text-to-speech module 232e may change the information in text form into information in voice form.

According to an embodiment, some or all of the functions of the natural language platform 232 may also be implemented in the electronic device 210.

The capsule database may store information about relationships between a plurality of concepts and actions corresponding to a plurality of domains. According to an embodiment, a capsule may include a plurality of action objects (or action information) and concept objects (or concept information) included in a plan. According to an embodiment, the capsule database may store a plurality of capsules in the form of a concept action network (CAN). According to an embodiment, the plurality of capsules may be stored in a function registry included in the capsule database.

The capsule database may include a strategy registry in which strategy information required for determining a plan corresponding to a user input is stored. The strategy information may include reference information for determining one plan when there are multiple plans corresponding to a user input. According to an embodiment, the capsule database may include a follow-up registry in which information on follow-up actions for suggesting follow-up actions to a user in a designated situation is stored. The follow-up actions may include, for example, follow-up utterances. According to an embodiment, the capsule database may include a layout registry in which layout information of information output through the electronic device 210 is stored. According to an embodiment, the capsule database may include a vocabulary registry in which vocabulary information included in the capsule information is stored. According to an embodiment, the capsule database may include a dialog registry in which information on a dialogue (or interaction) with a user is stored. The capsule database may allow stored objects to be updated through a developer tool. The developer tool may include, for example, a function editor for updating an action object or a concept object. The developer tool may include a vocabulary editor for updating a vocabulary. The developer tool may include a strategy editor for generating and registering a strategy that determines a plan. The developer tool may include a dialog editor for generating a dialogue with a user. The developer tool may include a follow-up editor capable of activating a follow-up goal and editing a follow-up utterance for providing a hint. The follow-up goal may be determined based on a currently configured goal, a user's preference, or an environmental condition. According to an embodiment, the capsule database may also be implemented within the electronic device 210.

According to an embodiment, the execution engine 233 may obtain a result by using the generated plan. The end user interface 234 may transmit the obtained result to the electronic device 210. Accordingly, the electronic device 210 may receive the result and provide the received result to the user. According to an embodiment, the management platform 235 may manage information used in the intelligent server 230. According to an embodiment, the big data platform 236 may collect user data. According to an embodiment, the analysis platform 237 may manage the quality of service (QOS) of the intelligent server 230. For example, the analysis platform 237 may manage the components and processing speed (or efficiency) of the intelligent server 230.

According to an embodiment, the service server 250 may provide, to the electronic device 210, a designated service (e.g., food ordering or hotel reservation). According to an embodiment, the service server 250 may be a server operated by a third party. According to an embodiment, the service server 250 may provide information for generating a plan corresponding to the received voice input to the intelligent server 230. The provided information may be stored in a capsule database. In addition, the service server 250 may provide result information according to the plan to the intelligent server 230. The service server 250 may include a plurality of service providers (e.g., CP service A 251, CP service B 252, and CP service C 253), and each of the service providers 251, 252, and 253 may provide a function for a domain related to each capsule stored in the capsule database 238 of the intelligent server 230.

In the integrated intelligence system described above, the electronic device 210 may provide various intelligent services to a user in response to user input. The user input may include, for example, input via a physical button, touch input, or voice input.

According to an embodiment, the electronic device 210 may provide a voice recognition service through an intelligent app (or, voice recognition app) stored therein. In this case, for example, the electronic device 210 may recognize a user utterance or voice input received through the microphone 212 and provide a service corresponding to the recognized voice input to the user.

According to an embodiment, the electronic device 210 may perform a designated operation based on the received voice input, alone or together with the intelligent server 230 and/or the service server 250. For example, the electronic device 210 may execute an app corresponding to the received voice input and perform a designated operation through the executed app.

According to an embodiment, when the electronic device 210 provides a service together with the intelligent server 230 and/or the service server 250, the electronic device 210 may detect a user utterance using the microphone 212 and generate a signal (or voice data) corresponding to the detected user utterance. The electronic device 210 may transmit the voice data to the intelligent server 230 using the communication interface 213 through the network 240.

The intelligent server 230 according to an embodiment may, in response to a voice input received from the electronic device 210, generate a plan for performing a task corresponding to the voice input, or a result obtained by performing an action according to the plan. The plan may include, for example, a plurality of actions for performing a task corresponding to a user's voice input, and a plurality of concepts related to the plurality of actions. The concept may define a parameter input to the execution of the plurality of actions, or a result value output by the execution of the plurality of actions. The plan may include association information between the plurality of actions and the plurality of concepts.

According to an embodiment, the electronic device 210 may receive the response using the communication interface 213. The electronic device 210 may output a voice signal generated within the electronic device 210 to the outside using the speaker 216, or may output an image generated within the electronic device 210 to the outside using the display module 211.

In FIG. 2, an example has been described in which voice recognition, natural language understanding and generation, and result generation using a plan for a user input received from the electronic device 210 are performed on the intelligent server 230. However, various embodiments of the disclosure are not limited thereto. For example, at least some components (e.g., the natural language platform 232, the execution engine 233, and the capsule database 238) of the intelligent server 230 may be embedded in the electronic device 210 (or the electronic device 101 of FIG. 1) such that their operations may be performed by the electronic device 210.

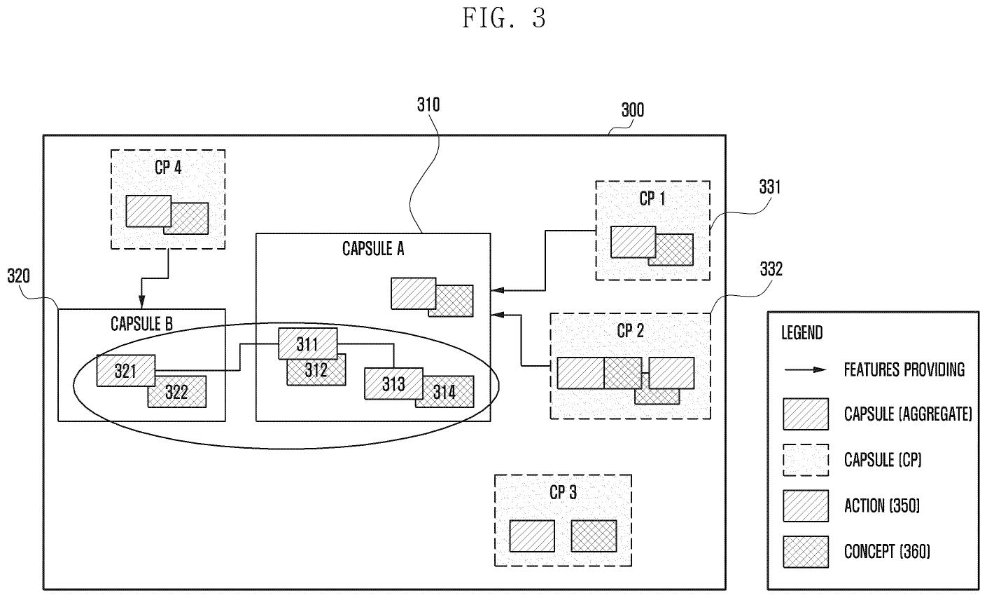

FIG. 3 illustrates a form in which relationship information between concepts and actions is stored in a database according to an embodiment of the disclosure.

According to an embodiment, a capsule database (e.g., the capsule database 238 of FIG. 2) of an intelligent server (e.g., the intelligent server 230 of FIG. 2) may store capsules in the form of a concept action network (CAN) 300. The capsule database may store, in the form of a concept action network (CAN), actions for processing tasks corresponding to a user's voice input and parameters required for the actions.

According to an embodiment, the capsule database may store a plurality of capsules (capsule A 310 and capsule B 320) corresponding to each of a plurality of domains (e.g., applications). According to an embodiment, one capsule (e.g., capsule A 310) may correspond to one domain (e.g., location (geo), application). In addition, one capsule may correspond to at least one service provider (e.g., CP 1 331 or CP 2 332) for performing a function for a domain related to the capsule. According to an embodiment, one capsule may include at least one action 350 and at least one concept 360 for performing a designated function.

According to an embodiment, the natural language platform (e.g., the natural language platform 232 of FIG. 2) may generate a plan for performing a task corresponding to a received voice input by using a capsule stored in a capsule database. For example, the planner module of the natural language platform (e.g., the planner module 232c of FIG. 2) may generate a plan using a capsule stored in a capsule database. For example, the plan may be generated using actions 311 and 313 and concepts 312 and 314 of the capsule A 310 and action 321 and concept 322 of the capsule B 320.

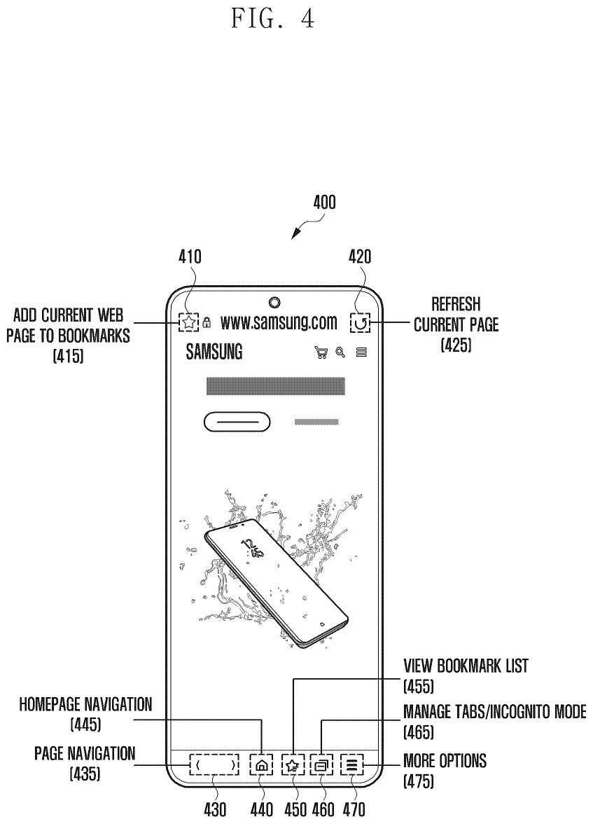

FIG. 4 illustrates one page of input data according to an embodiment of the disclosure.

According to an embodiment, the input data to be used for a user's question and answer may be multi-modal data including various content types. For example, the content type of the input data may include text, a table, an image, a video, or audio, but is not limited thereto.

FIG. 4 illustrates an example of input data, which is a page 400 in a manual file of a specific device that provides information related to Internet menu settings. Such input data may be used in Device QA, which is a service providing information related to the device.

Referring to FIG. 4, input data may include a bookmark setting icon 410 and text information 415, a refresh icon 420 and text information 425, a page-navigation icon 430 and text information 435, a homepage-navigation icon 440 and text information 445, a bookmark-list view icon 450 and text information 455, a tab management icon 460 and text information 465, and a more-options icon 470 and text information 475. When extracting each content item from the input data, each of the icons 410, 420, 430, 440, 450, 460, and 470 may be extracted as image content, and each of the text information items 415, 425, 435, 445, 455, 465, 475 may be extracted as text content.

According to an embodiment, a QA service provided by an electronic device (e.g., the electronic device 101 of FIG. 1 or the electronic device 210 of FIG. 2) may answer, in the form of text, with text information of input data in response to a user query. For example, when crawling a PDF file serving as input data, the electronic device may extract only text that can be processed in natural language. In this case, with respect to a user query such as “How do I set a bookmark?”, the electronic device may provide an answer such as the text information “Add current web page to bookmark” (indicated by reference numeral 415). However, since the actual user query may be intended to ask which icon should be touched to set a bookmark, answering only with text information as described above may not be appropriate for the user's intent. Alternatively, a method of converting a bookmark setting icon 410 into text content and providing it to the user may be considered, but it may not be easy to convert the bookmark setting icon 410 into text content.

Hereinafter, with reference to FIGS. 4 to 6, 7A, 7B, 8A, 8B, 9A, 9B, and 10A to 10C, various embodiments will be described for generating queries in a format capable of supporting data distributed in various forms of modalities, and for comparing the generated queries to provide answers to a user query not only in text form but also in various modalities (e.g., image, audio, video).

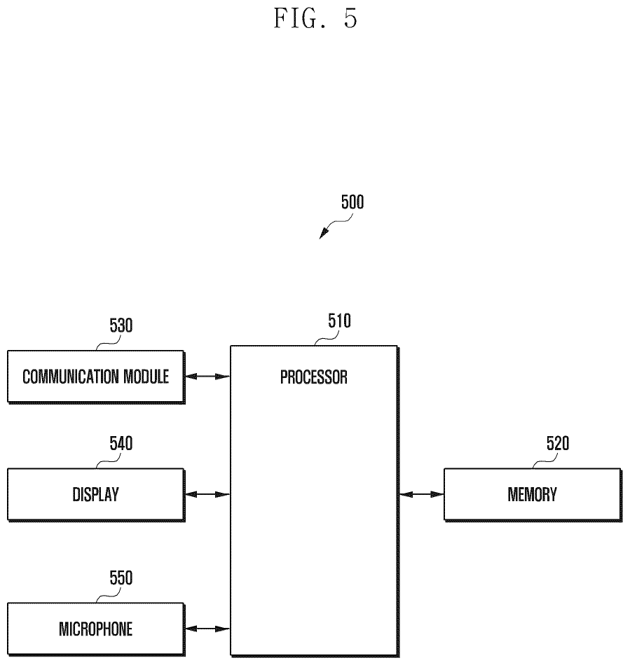

FIG. 5 is a block diagram of an electronic device according to an embodiment of the disclosure.

Referring to FIG. 5, an electronic device 500 may include a processor 510, memory 520, a communication module 530, a display 540, and a microphone 550. In various embodiments of the disclosure, some of the illustrated configurations may be omitted or replaced. The electronic device 500 may include at least some of the components and/or functions of the electronic device 101 of FIG. 1 and/or the electronic device 210 of FIG. 2. At least some of the respective components of electronic device 500, whether illustrated or not, may be operatively, functionally, and/or electrically connected to each other.

According to an embodiment, the display 540 may display various images provided from the processor 510. For example, the display 540 may be implemented as any one of a liquid crystal display (LCD), a light-emitting diode (LED) display, an organic light-emitting diode (OLED) display, a micro electro mechanical systems (MEMS) display, or an electronic paper display, but is not limited thereto. The display 540 may be configured as a touch screen that detects touch and/or proximity touch (or hovering) input using a part of a user's body (e.g., a finger) or an input device (e.g., a stylus pen). The display 540 may include at least some of the components and/or functions of the display module 160 of FIG. 1 and/or the display module 211 of FIG. 2.

According to an embodiment, when a voice assistant is executed by the processor 510, the display 540 may display various screens provided by the voice assistant. According to an embodiment, the voice assistant may be configured as a conversational user interface (UI).

According to an embodiment, the microphone 550 may pick up external sounds, such as a user's voice, and convert them into a voice signal, which is digital data. According to an embodiment, the electronic device 500 may include a microphone in a part of a housing (not shown), or may receive a voice signal picked up by an external microphone connected wired or wirelessly. For example, when a voice assistant is executed, the microphone 550 may acquire a user utterance for question-and-answer (e.g., Device QA) and provide the utterance to the processor 510.

According to an embodiment, the communication module 530 may support wireless communication with an external device using cellular wireless communication (e.g., 4G LTE, 5G NR) and/or short-range wireless communication (e.g., Wi-Fi). For example, the electronic device 500 may communicate, via the communication module 530, with an external server that provides a voice assistant function through a network. The communication module 530 may include at least some of the components and/or functions of the communication module 190 of FIG. 1 and/or the communication interface 213 of FIG. 2.

According to an embodiment, the memory 520 may include volatile memory and non-volatile memory, and may temporarily or permanently store various data. The memory 520 may include at least some of the components and/or functions of the memory 130 of FIG. 1 and/or the memory 215 of FIG. 2, and may store the program 140 of FIG. 1. The memory 520 may store various applications (e.g., the first app 219a and the second app 219b of FIG. 2), and a program module supporting intelligent services (e.g., the client module 218 of FIG. 2).

According to an embodiment, the memory 520 may store various instructions that can be performed by the processor 510. Such instructions may include control commands such as arithmetic and logical actions, data movement, and/or input/output that can be recognized by the processor 510.

According to an embodiment, the processor 510 may be configured, as a configuration capable of performing operations or data processing related to control and/or communication of respective components of the electronic device 500, to include one or more processors. The processor 510 may include at least some of the components and/or functions of the processor 120 of FIG. 1 and/or the processor 214 of FIG. 2.

According to an embodiment, there is no limitation to the operations and data processing functions that the processor 510 may implement on the electronic device 500. However, in the disclosure, various embodiments will be described in which input data is analyzed to generate candidate queries and candidate answers, and appropriate answers are provided in response to a user utterance when providing a question-and-answer service using a voice assistant. The operations of the processor 510 described below may be performed by loading instructions stored in the memory 520.

In the disclosure, a description that the processor 510 may perform a certain operation (or function, work, task) may be construed as substantially the same as meaning that instructions (or commands, computer programs) for causing the electronic device 500 (or the processor 510) to perform the corresponding operation are stored in the memory 520 (e.g., non-volatile memory, storage). In addition, a description that the processor 510 may perform a certain operation may be construed as substantially the same as meaning that at least one unspecified processor 510 may perform the corresponding operation.

According to an embodiment, the processor 510 may execute a voice assistant application that provides an intelligent service. For example, the voice assistant may be configured as a conversational user interface (UI), and text information corresponding to a user utterance and an answer provided by the voice assistant may be provided through the conversational UI.

Hereinafter, an operation of analyzing input data to generate candidate queries and candidate answers when an electronic device 500 provides a question-and-answer service, which is a function of a voice assistant, will be described. Hereinafter, each operation may be described as being performed in the electronic device 500, but at least some of the operations may be performed in an external server, and the electronic device 500 may operate by receiving result values from the external server.

According to an embodiment, the processor 510 may obtain input data to be analyzed. For example, the input data may be in the form of a file, such as a document, or may be data from various sources, such as a web page on the Internet, a video, or audio streaming.

According to an embodiment, the input data may be multi-modal data including various types (or modalities) of content. For example, the input data may include various types of content, such as text, tables, images, audio, and video.

According to an embodiment, the processor 510 may analyze the input data and classify each content item included in the input data by type. The processor 510 may store the classified content item of each type as text information. For example, the processor 510 may analyze the image content of the input data by using an optical character recognition (OCR) module and output the interpreted text information together with metadata (e.g., location, size). In addition, the processor 510 may analyze the audio and/or video content of the data by using an automatic speech recognition (ASR) module and output speech-converted text together with metadata (e.g., start time, end time, length).

According to an embodiment, the processor 510 may index the content item of each type in the input data. For example, the processor 510 may assign an index to text content, image content, and table content included in the input data.

According to an embodiment, the processor 510 may generate at least one candidate query corresponding to each indexed content item of the input data. For example, the processor 510 may generate a possible query (e.g., “Tell me how to bookmark”) from text (e.g., bookmark) extracted from the input data. The processor 510 may index the generated candidate queries and store them. For example, referring to the Internet menu setting page of FIG. 4, the title of the corresponding page, which is image data, is “Internet Menu”, and the text “Bookmark” may be extracted from the image data. The electronic device 500 may generate “How to bookmark”, “How do I set a bookmark”, and “I want to bookmark a web page” as candidate queries from the extracted text “Bookmark”, and may assign the same index (e.g., 43) as that of the content item serving as the basis for the candidate queries.

According to an embodiment, the processor 510 may select, from among a plurality of content items, at least one content item corresponding to the candidate query, and determine the selected at least one content item as a candidate answer. The processor 510 may match the generated candidate query and the content item assigned with the same index, and store them. For example, the image content including a bookmark button assigned the same index may be matched with and stored together with the candidate query “How to bookmark”.

According to an embodiment, the processor 510 may determine a candidate answer corresponding to a candidate query using various types of content. Previously, the form of the answer was limited to text, and thus when only a specific text portion was extracted from image content and provided as an answer, it may be difficult for a user to understand. Since the processor 510 may match various types of content to a candidate answer corresponding to a candidate query, the answer may be provided in another type of content, such as image content, rather than text.

According to an embodiment, when a plurality of content items are selected and determined as candidate answers, the processor 510 may assign a ranking (or priority) to the selected plurality of content items. An answer to a specific query may not be found in only one piece of data, but may be provided with relevant information in various media, such as a specific web page, a document-based manual, a wiki, a snippet of a search result, video streaming, or audio streaming. In other words, an answer may be included in only specific data, or may exist in multiple locations depending on the characteristics of the query. The electronic device 500 may determine the ranking of an answer, based on the query of each indexed content item. The electronic device 500 may index and process information of various data (or media) based on a query and, since the information is indexed based on an answerable query, it may provide an answer regardless of the type of content being output even if necessary information is included in various data.

According to an embodiment, when the input data is video or audio streaming data, the processor 510 may determine a candidate answer by using a time section including a content item corresponding to a candidate query. For example, when an answer is included in a specific part of a video caption, the corresponding location may be marked to configure the answer in the form of a uniform resource locator (URL)+time section.

According to an embodiment, the electronic device 500 may receive a user query through at least one input device. For example, the electronic device 500 may receive a user query through a user's touch input on the display 540 and/or a voice input using the microphone 550. When a user query is received, the processor 510 may select a candidate query corresponding to the user query, and select at least one of candidate answers stored to match with the selected candidate query, and provide the at least one selected candidate answer to the user as an answer.

According to an embodiment, the processor 510 may determine a plurality of queries from a received user query, determine a plurality of candidate answers respectively matched to the plurality of queries, and generate an answer to be provided to the user by combining the determined plurality of candidate answers. According to an embodiment, when the processor 510 determines a first query and a second query from the user query, the processor 510 may determine a first type of candidate answer corresponding to the first query and a second type of candidate answer corresponding to the second query.

In general, when information from two or more modalities needs to be combined to provide an answer, the processing may become relatively complicated. For example, a method such as image-to-text or text-to-image may be used, but this approach has a significant limitation on the search space, which is a fundamental issue in QA, and it may not be realistically easy to compare data in its original modality. Accordingly, when there is a query in the form of a complex sentence, the electronic device 500 may decompose the complex-sentence query, based on a query generated in a single-sentence form, and compare the decomposed queries with the content. In this case, the search space may be reduced by comparing data of other types of content based on the query.

For example, when a user query is “Which one has a larger screen size between S21 and S22?”, information on the screen size of S21 and the screen size of S22 may be required. In this case, the screen size information of S21 may be identified from text content, and the screen size information of S22 may be identified from table content. The processor 510 may extract an answer corresponding to the query from the two identified content items.

According to an embodiment, the processor 510 may generate a new candidate query by combining two or more queries, and may assign a new index to the generated new query. For example, by combining two queries, a new query such as “Which one has a larger screen size between S21 and S22?” may be generated, and the query and the generated answer may be stored to match with each other.

According to an embodiment, when the input data is internal data stored in the memory 520, the processor 510 may configure a higher weight for the content included in the internal data than for the content of data acquired externally via the communication module 530. For example, the electronic device 500 may store personalized information such as text messages, contacts, and memos. The processor 510 may perform learning by giving a higher weight to the content including personalized information stored internally in the electronic device 500 than to the content searched externally (e.g., the Internet).

Instructions for performing operations of the electronic device 500 (or processor 510) described above may be stored in a computer-readable recording medium. The recording medium may be tangible and non-transitory. The recording medium may store one or more computer programs including the instructions.

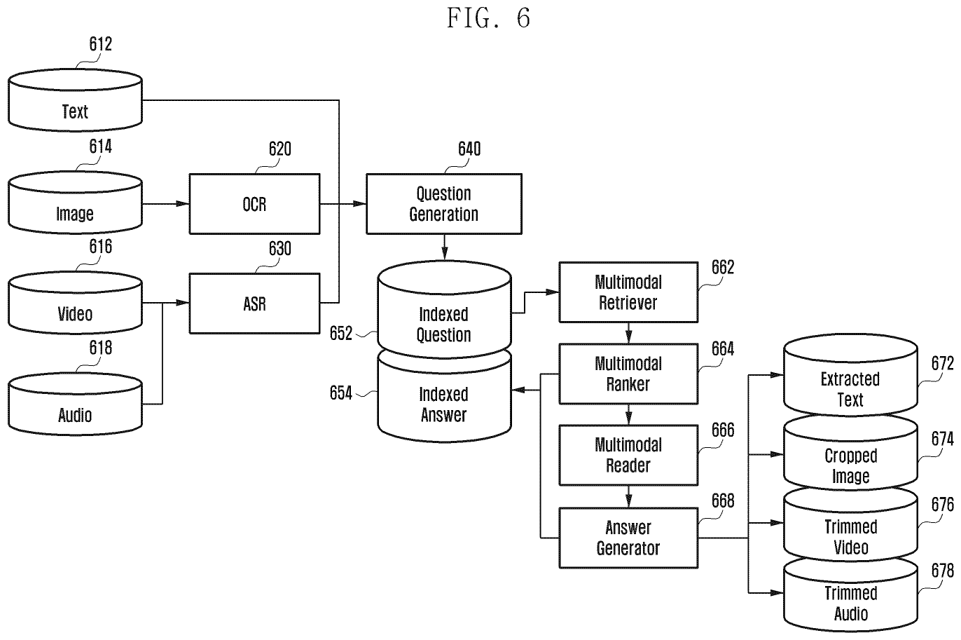

FIG. 6 is a software block diagram for QA processing of an electronic device according to an embodiment of the disclosure.

FIG. 6 illustrates each module constituting a voice assistant engine, which may be implemented in an electronic device (e.g., the electronic device 500 of FIG. 5 or an external server.

According to an embodiment, the voice assistant engine may analyze input data including various types of content. For example, the types of input data may include text 612, image 614, video 616, and audio 618, but are not limited thereto.

According to an embodiment, an OCR module 620 and an ASR module 630 may analyze input data and output various types of content of the input data as text information. Optical character recognition (OCR) is a process of analyzing an image including characters written or printed by a person and converts the same into a text format readable by a machine. For example, the OCR may include processes such as preprocessing, pattern matching, feature extraction, and postprocessing for image data. The OCR module 620 may analyze image content of the input data and output interpreted text information and metadata (e.g., location, size).

According to an embodiment, automatic speech recognition (ASR) may refer to interpreting a spoken language uttered by a person and converting the content into a character-based form. For example, ASR may include processes such as speech preprocessing, pattern processing, and language processing based on a language model. The ASR module 630 may analyze audio and/or video content of input data and output text converted from speech and metadata (e.g., start time, end time, length).

According to an embodiment, the question generation module 640 may perform an operation of generating various queries from input data. The question generation module 640 may receive text content 612 of the input data, text that has been converted from the image content 614 by the OCR module 620, and/or text recognized by the ASR module 630. According to an embodiment, the question generation module 640 may, based on the input text information, generate at least one query that may be presented from the text information. For example, in the Internet menu setting page of FIG. 4, the module may recognize text such as “Add current web page to bookmarks”, infer a query based on the recognized text, and generate, as a query for the input data, a query such as “How do I set a bookmark?”. The question generation module 640 may index the generated query and store the same as an indexed query 652.

According to an embodiment, a multi-modal retriever 662, a multi-modal ranker 664, and a multi-modal reader 666 may implement a function of machine reading comprehension (MRC). According to an embodiment, the multi-modal retriever 662 may search for a content item that may serve as an answer to a query among various content items. The multi-modal ranker 664 may rearrange documents among the found content items according to the degree of relevance to the answer. The multi-modal reader 666 may find the answer within the rearranged documents.

According to an embodiment, an answer generation module 668 may generate answers in various modalities (or types). The answer generation module 668 may assign the same index as the corresponding query to each generated answer, and may match the generated answer with the query and store them as an indexed answer 654.

According to an embodiment, the answer generated by the answer generation module 668 may include at least one of extracted text content 672, cropped image content 674, trimmed video content 676, and trimmed audio content 678 from the input data.

According to an embodiment, the electronic device may generate a query for input data including content of various modalities (e.g., text, image, audio, video), rank content of various modalities based on the generated query, and output an answer including content of various modalities.

According to an embodiment, the electronic device may assign a ranking to each answer, based on the query of each indexed content item. According to an embodiment, when matching a query and an answer, the electronic device may assign a ranking based on the similarity between the query and the answer.

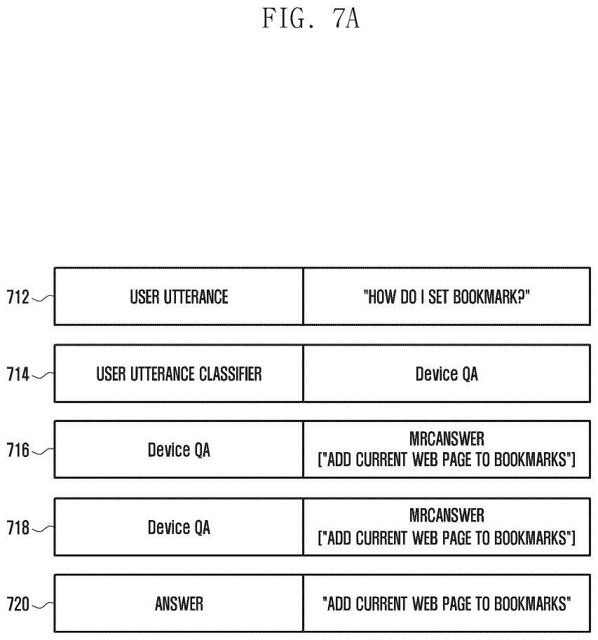

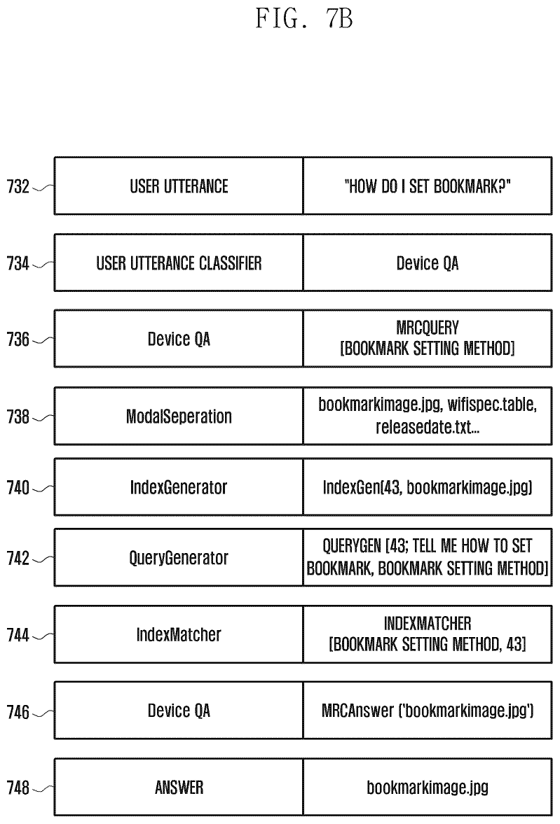

Hereinafter, with reference to FIGS. 7A, 7B, 8A, 8B, 9A, 9B, and 10A to 10C, various embodiments will be described in which an electronic device (e.g., the electronic device 500 of FIG. 5) processes question-and-answer in response to a user utterance. Hereinafter, although the illustrated operations will be described as being performed by the electronic device (e.g., the electronic device 500 of FIG. 5), at least some of the illustrated operations may be performed by an external server connected to the electronic device.

FIGS. 7A and 7B illustrate a question-and-answer providing method of an electronic device according to various embodiments of the disclosure.

FIG. 7A illustrates an example in which, in response to a user query, an electronic device or an external server providing a voice assistant service answers with text content obtained from a manual document including the Internet menu setting page 400 of FIG. 4.

According to an embodiment, in operation 712, a user may activate a voice assistant function of the electronic device and input, for example, “How do I set a bookmark?”.

According to an embodiment, in operation 714, a user utterance classifier of the electronic device (or the external server) may identify that the input user utterance belongs to a device QA category, and may identify a generated query and answer by analyzing the Internet menu setting page, which is the input data.

According to an embodiment, in operation 716, the electronic device may analyze the user utterance “How do I set a bookmark” using machine reading comprehension (MRC) and determine “Bookmark setting method” as the query matching the user utterance.

According to an embodiment, in operation 718, the electronic device may determine “Add current webpage to bookmarks” as an answer matching the query “Bookmark setting method”. For example, the text content obtained in FIG. 4 includes “Add current webpage to bookmarks” and “View bookmark list”, both including the wording “bookmark”, and “Add current webpage to bookmarks” may be assigned a higher ranking with respect to the query “Bookmark setting method”. The electronic device may output the answer with the highest ranking among the answers matched to the query.

According to an embodiment, in operation 720, the electronic device may output text information, “Add current web page to bookmarks,” as an answer to the user utterance. For example, the electronic device may output the text on a display (e.g., the display 540 of FIG. 5) or output the text as audio through a speaker (e.g., the speaker 216 of FIG. 2).

As such, when an answer is provided only with text information in response to a user utterance, the answer may not be intuitive with respect to the user's intent to set a bookmark.

FIG. 7B illustrates an example in which, in response to a user query, an electronic device or external server providing a voice assistant service answers with the Internet menu setting page 400 of FIG. 4, provided as image content in a manual document.

In the following embodiments, the operations may be performed sequentially, but are not necessarily performed sequentially. For example, the order of the operations may be changed, and at least two operations may be performed in parallel.

According to an embodiment, operations 732 to 748 may be understood to be performed in a processor (e.g., the processor 510 of FIG. 5) of an electronic device (e.g., the electronic device 500 of FIG. 5).

According to an embodiment, in operation 732, the user may activate a voice assistant function of the electronic device and input something such as “How do I set a bookmark?”

According to an embodiment, in operation 734, a user utterance classifier of the electronic device (or the external server) may identify that an input user utterance belongs to a device QA category, and may identify a generated query and answer by analyzing the Internet menu setting page as input data.

According to an embodiment, the electronic device (or the external server) may pre-generate various queries and at least one answer matching the queries from input data, prior to the user utterance.

According to an embodiment, in operation 736, the electronic device may analyze the user utterance “How do I set a bookmark” using machine reading comprehension (MRC), and determine “Bookmark setting method” as the query matching the user utterance.

According to an embodiment, in operation 738, a modal separation module may classify each content item included in the input data according to the type of the content (e.g., image, table, text). For example, an optical character recognition (OCR) module (e.g., the OCR module 620 of FIG. 6) of the electronic device (or the external server) may recognize various types of content included in a document, based on the content used for learning through a classifier in the OCR module, and may distinguish each content item according to its type.

According to an embodiment, in operation 740, the index generator module may assign an index to each acquired content item. For example, an index 43 may be assigned to a bookmark image (e.g., bookmarkimage.jpg).

According to an embodiment, in operation 742, a query generator module may generate various queries from each indexed content item. According to an embodiment, the query generator module of the electronic device (e.g., the question generation module 640 of FIG. 6) may generate possible queries (e.g., “Tell me how to bookmark”) from text extracted from the input data, such as a title (e.g., bookmark). The query generator module may index the generated queries and store them. According to an embodiment, referring to the Internet menu setting page of FIG. 4, the title of the corresponding page, which is image data, is “Internet Menu”, and the text “bookmark” may be extracted from the image data. The electronic device may generate “How to bookmark”, “How do I set a bookmark”, and “I want to bookmark a web page” as candidate queries from the extracted text “Bookmark”, and may assign the same index (e.g., 43) as that of the content item serving as the basis for the candidate queries.

According to an embodiment, in operation 744, the index matching module may match the generated candidate queries and content items assigned with the same index and store them. According to an embodiment, a multi-modal retriever of the electronic device (e.g., the multi-modal retriever 662 of FIG. 6) may narrow down, from the input data, a set of candidates to be searched for query matching. Such generation of candidate queries may be configured prior to a user utterance based on the input data. According to another embodiment, candidate queries may be generated by searching documents acquired through an external database or the Internet upon operation of the voice assistant in response to a user utterance input.

According to an embodiment, a multi-modal ranker (e.g., the multi-modal ranker 664 of FIG. 6) may assign rankings to a candidate query and multiple answers matching the candidate query, and rearrange the order in which the answers are to be output based on the rankings.

According to an embodiment, operations 738 to 744 may be performed in advance by analyzing input data prior to receiving the user utterance.

According to an embodiment, in operation 746, the electronic device may determine the image content “bookmarkimage.jpg” as an answer matching the query “Bookmark setting method”. According to an embodiment, the multi-modal reader may determine an index of an answer corresponding to the query, and the answer generation module may extract and output an answer based on the determined index. For example, among the content items included in the input data that are indexed for the candidate query “Bookmark setting method”, “bookmarkimage.jpg” may be assigned the highest ranking, and the electronic device may determine the highest-ranking “bookmarkimage.jpg” as the answer.

According to an embodiment, in operation 748, the electronic device may output image information, “bookmarkimage.jpg,” through the display as an answer to the user utterance. For example, the electronic device may output, to the display (e.g., the display 540 of FIG. 5), the entire page 400 of FIG. 4 determined as the answer.

In contrast to the operation illustrated in FIG. 7A, the operation illustrated in FIG. 7B provides an answer with image information rather than text information, thereby providing a voice assistant service that matches the user's intent.

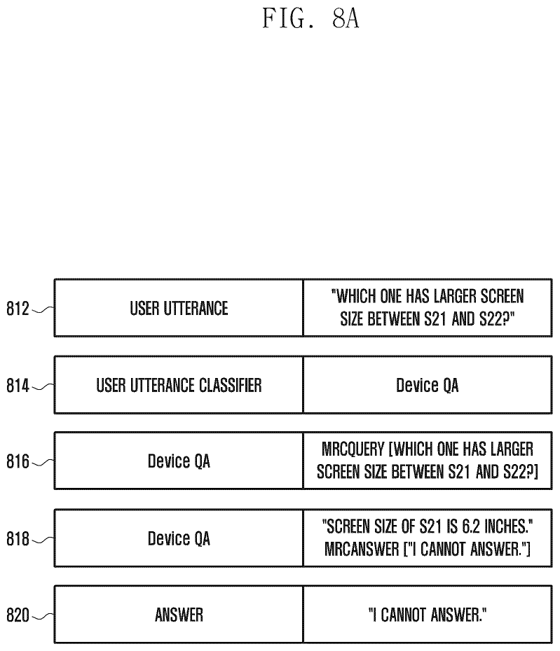

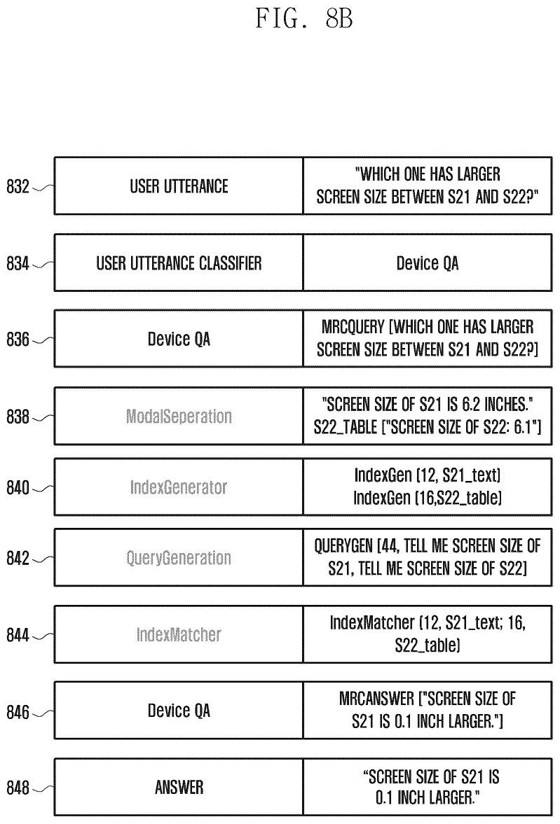

FIGS. 8A and 8B illustrate a question-and-answer providing method of an electronic device according to various embodiments of the disclosure.

FIG. 8A illustrates an example in which, in response to a user query, an electronic device or an external server providing a voice assistant service answers by using content of one type (e.g., text) acquired from one input data. S21 and S22 described below may be model names of electronic devices (e.g., smartphones), and the screen sizes of S21 and S22 may be different from each other. The input data acquired from the electronic device may be a manual file of the electronic device, and in the manual file, information about the screen size of S21 may be provided as text information, or information about the screen size of S22 may not be provided or may be provided only in another type (e.g., table).

According to an embodiment, in operation 812, the user may activate a voice assistant function of the electronic device and input something like, “Which one has a larger screen size between S21 and S22?”

According to an embodiment, in operation 814, a user utterance classifier of the electronic device (or the external server) may determine that the input user utterance belongs to the device QA category.

According to an embodiment, in operation 816, the electronic device may analyze the user utterance “Which one has a larger screen size between S21 and S22?” using machine reading comprehension (MRC) and identify a corresponding query.

According to an embodiment, in operation 818, the electronic device may search, in the input data, for content related to the query “Which one has a larger screen size between S21 and S22?”. The electronic device may identify “The screen size of S21 is 6.2 inches” as text information related to the screen size of S21 in the input data, but may not identify text content about the screen size of S22 in the same input data. Accordingly, the electronic device may determine that it is unable to answer the user query, and may generate an answer including information indicating inability to answer, such as “I cannot answer.”

According to an embodiment, in operation 820, the electronic device may output “I cannot answer” as an answer to the user utterance, indicating inability to answer.

In the embodiment of FIG. 8A, when a user query is a complex sentence that requires results from different modalities, there may be a problem in that an accurate answer cannot be provided because content of different types (or modalities) cannot be utilized. As in this example, when content of different types exists, it is possible to determine multiple queries and answers after converting the content types into the same type, such as image-to-text or text-to-image. However, this method may not be easy to implement because it imposes a significant limitation on the search space, which is a fundamental problem of QA.

FIG. 8B illustrates an example in which, in response to a user query, an electronic device or external server providing a voice assistant service answers by using various types of content.

In the following embodiments, the operations may be performed sequentially, but are not necessarily performed sequentially. For example, the order of the operations may be changed, and at least two operations may be performed in parallel.

According to an embodiment, operations 832 to 848 may be understood to be performed in a processor (e.g., the processor 510 of FIG. 5) of an electronic device (e.g., the electronic device 500 of FIG. 5).

According to an embodiment, in operation 832, the user may activate the voice assistant function of the electronic device and input something like, “Which one has a larger screen size between S21 and S22?”

According to an embodiment, in operation 834, a user utterance classifier of the electronic device (or the external server) may determine that the input user utterance belongs to the device QA category.

According to an embodiment, in operation 836, the electronic device may analyze the user utterance “Which one has a larger screen size between S21 and S22?” using machine reading comprehension (MRC) and identify a corresponding query.

According to an embodiment, the device QA may be provided with relevant information from various media, such as a specific web page, a document-based manual, a wiki, a snippet of a search result, video streaming, and audio streaming. In the device QA, the content required for an answer may be included only in specific input data (or media), or, depending on the nature of the query, an answer may be possible only by using multiple content items. For example, the query “Which one has a larger screen size between S21 and S22?” requires information about the screen size of S21 and information about the screen size of S22, each of which may be included in different types (or modalities) of content.

According to an embodiment, in operation 838, the modal separation module may classify content items included in the input data according to the type of the content (e.g., image, table, text). For example, in a manual file, text information such as “the screen size of S21 is 6.2 inches” may be obtained, and table content, S22_table, including the screen size information of S22, may be obtained. According to another embodiment, the electronic device may obtain text content including the screen size information of S21 and table content including the screen size information of S22 from different data, respectively.

According to an embodiment, in operation 840, the index generator module may assign an index to each acquired content item. For example, the index generator module may assign an index 12 to the acquired text content “the screen size of S21 is 6.2 inches” and an index 16 to the acquired table content S22_table.

According to an embodiment, in operation 842, the query generator module may generate various queries from each indexed content item. For example, the query generator module may generate a candidate query “Tell me the screen size of S21” from the acquired text content “The screen size of S21 is 6.2 inches”, and assign an index 12, which is the same as the content's index, to the candidate query. In addition, the candidate query “Tell me the screen size of S22” may be generated from the table content S22_table, and assign an index 16, which is the same as the content's index, to the candidate query. The query generator module may integrate the candidate queries “Tell me the screen size of S21” and “Tell me the screen size of S22” generated from multiple content items into a single candidate query, and may assign a new index (e.g., 44) thereto.

According to an embodiment, in operation 844, an index matching module may match the content and the generated candidate queries, assigned with the same index (e.g., 12, 16), and store them in memory (e.g., the memory 520 of FIG. 5).

According to an embodiment, operations 838 to 844 may be performed in advance by analyzing the input data prior to receiving the user utterance.

According to an embodiment, in operation 846, the electronic device may generate text content “the screen size of S21 is 0.1 inch larger” as an answer matching the query “Which one has a larger screen size between S21 and S22?”. For example, the electronic device may identify the short-form queries “Tell me the screen size of S21” and “Tell me the screen size of S22” that match the complex-form query, identify the answers “S21 has a screen size of 6.2 inches” and the S22_table that match the indexes of the two generated queries, and generate a final answer “S21 is 0.1 inch larger” from the two identified answers.

According to an embodiment, in operation 848, the electronic device may, as an answer to the user utterance, output text information, “S21 is 0.1 inches larger,” through a display (e.g., the display 540 of FIG. 5).

In contrast to the operation illustrated in FIG. 8A, the operation illustrated in FIG. 8B may generate an answer to a complex-sentence query by combining two different types of content.

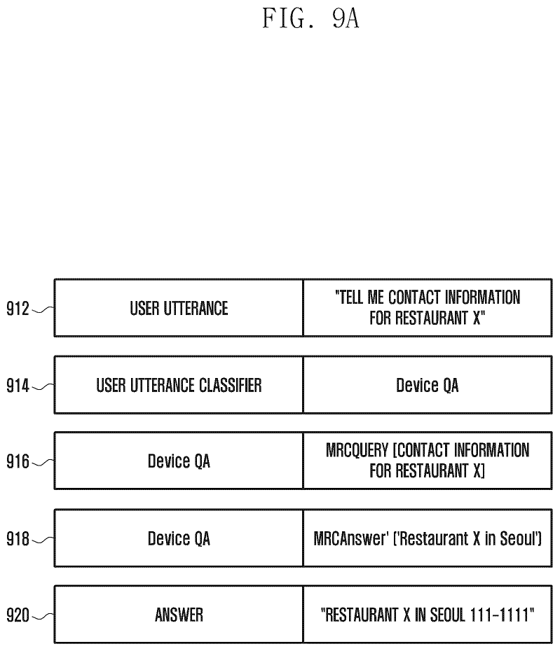

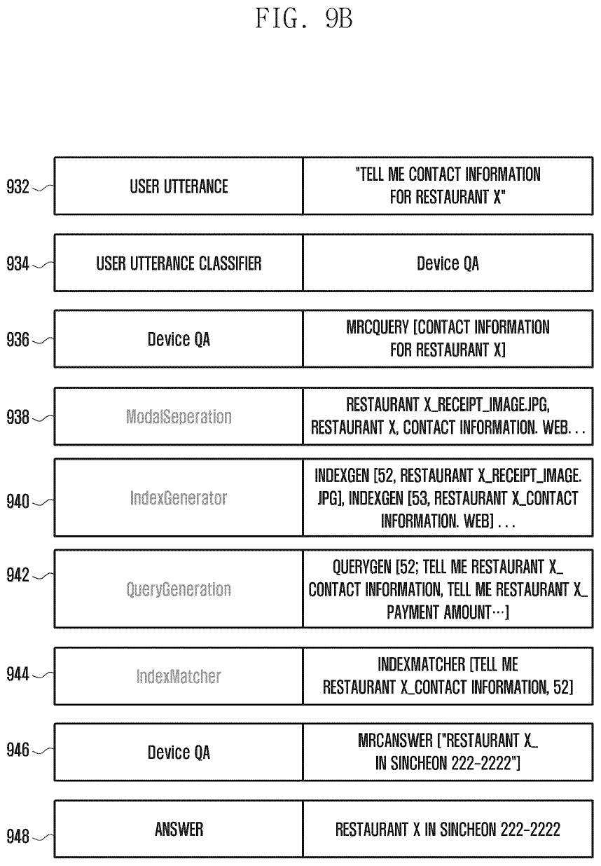

FIGS. 9A and 9B illustrate a question and answer providing method of an electronic device according to various embodiments of the disclosure.

FIG. 9A illustrates an example in which, in response to a user query, an electronic device or external server providing a voice assistant service answers by using only data including general facts, such as those obtained through an Internet search.

According to an embodiment, in operation 912, the user may activate the voice assistant function of the electronic device and input something like, “Tell me the contact information for restaurant X.”

According to an embodiment, in operation 914, a user utterance classifier of the electronic device (or the external server) may determine that the input user utterance belongs to the QA category.

According to an embodiment, in operation 916, the electronic device may analyze the user utterance “Tell me the contact information for restaurant X” using machine reading comprehension (MRC) and determine “Restaurant X contact information” as the query matching the user utterance.

According to an embodiment, in operation 918, the electronic device may identify “Restaurant X Seoul Branch” as an answer matching the query “Restaurant X contact information”. For example, the electronic device may identify contact information for Restaurant X on the Internet, and identify the contact information for one of the identified Restaurants X branches, namely, the Seoul Branch.

According to an embodiment, in operation 920, the electronic device may output text information, “Restaurant X Seoul Branch, 111-1111,” as an answer to the user utterance.

Likewise, even when the actual user wants to know the contact information for another branch of Restaurant X, relying only on publicly available information such as an Internet search in response to the user utterance may provide a result different from the user's intent.

FIG. 9B illustrates an example in which, in response to a user query, an electronic device or an external server providing a voice assistant service answers by using data including personalized information of a user of the electronic device.

In the following embodiments, the operations may be performed sequentially, but are not necessarily performed sequentially. For example, the order of the operations may be changed, and at least two operations may be performed in parallel.

According to an embodiment, operations 932 to 948 may be understood to be performed in a processor (e.g., the processor 510 of FIG. 5) of an electronic device (e.g., the electronic device 500 of FIG. 5).

According to an embodiment, in operation 932, the user may activate the voice assistant function of the electronic device and input something like, “Tell me the contact information for restaurant X.”

According to an embodiment, in operation 934, a user utterance classifier of the electronic device (or the external server) may determine that the input user utterance belongs to the QA category.

According to an embodiment, in operation 936, the electronic device may analyze the user utterance “Tell me the contact information for restaurant X” using machine reading comprehension (MRC) and identify the corresponding query as “Restaurant X contact information.”

According to an embodiment, the electronic device may store personalized information, such as text messages, contacts, and notes. For example, when there is a query such as “restaurant X contact information”, as in this example, contact information of multiple branches may be retrieved by searching for the contact information for restaurant X on the Internet. In this case, when the electronic device uses the user's personalized information, it may extract an answer that better corresponds to the user's intent, and to this end, the personalized information may need to be given priority in processing.

According to an embodiment, the electronic device may perform learning by assigning a higher weight to content stored internally in the electronic device than to content retrieved externally (e.g., the Internet).

According to an embodiment, in operation 938, the modal separation module may classify each content item included in the input data according to the type of the content (e.g., image, table, text). For example, the modal separation module may identify an image of a receipt for Restaurant X, which is an image content stored in the memory of the electronic device, and contact information for restaurant X from the contacts application.

According to an embodiment, in operation 940, the index generator module may assign an index to each acquired content item. For example, the index generator module may assign an index 52 to a receipt image of restaurant X, which is an acquired image content, and may assign an index 53 to the contact information for restaurant X acquired from the contacts application. According to an embodiment, the index generator module may assign a different index and a lower weight to a content item acquired through an external search, such as the Internet, rather than to internal information of the electronic device.

According to an embodiment, in operation 942, the query generator module may generate corresponding queries from the indexed content item. For example, the query generator module may generate candidate queries, “Tell me the contact information for restaurant X” and “Tell me the payment amount of restaurant X,” in response to a receipt image of restaurant X, which is an image content. The query generator module may assign the same index (e.g., 53, 52) as the content to each generated candidate query.

According to an embodiment, in operation 944, the index matching module may match the generated candidate queries and content items assigned with the same index and store them in memory (e.g., the memory 520 of FIG. 5). In this case, an answer including contact information for multiple branches may be matched for one query “Tell me the contact information for restaurant X”, and among these, a content item obtained based on internal information of the electronic device may be given a high ranking, while a content item obtained through an external search may be given a low ranking.

According to an embodiment, operations 938 to 944 may be performed in advance by analyzing input data before receiving the user utterance.

According to an embodiment, in operation 946, the electronic device may generate text content “Restaurant X Sincheon Branch 222-2222” as an answer matching the query “Tell me the contact information for restaurant X.” For example, the electronic device may extract the contact information as text through OCR from image content matching the query, and provide the extracted contact information.

According to an embodiment, in operation 948, the electronic device may output text information “Restaurant X Sincheon Branch 222-2222” through a display (e.g., the display 540 of FIG. 5) as an answer to the user utterance.

In contrast to the operations illustrated in FIG. 9A, the operations illustrated in FIG. 9B may provide a more accurate answer to the user query intent by using personalized information to extract an answer corresponding to the query.

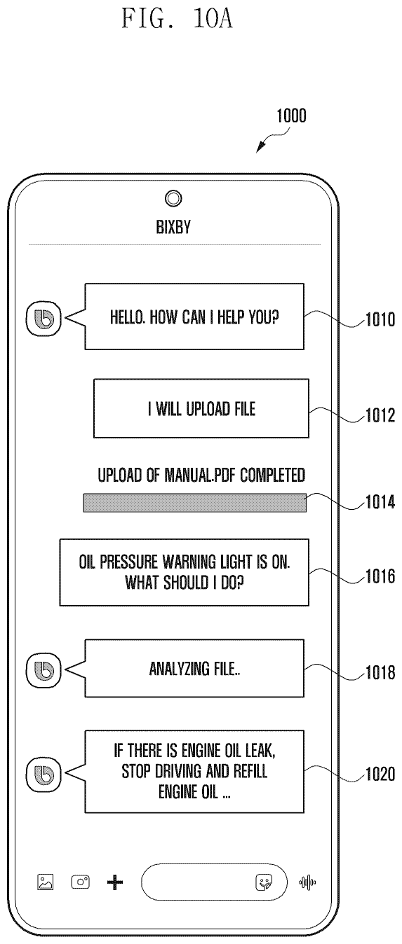

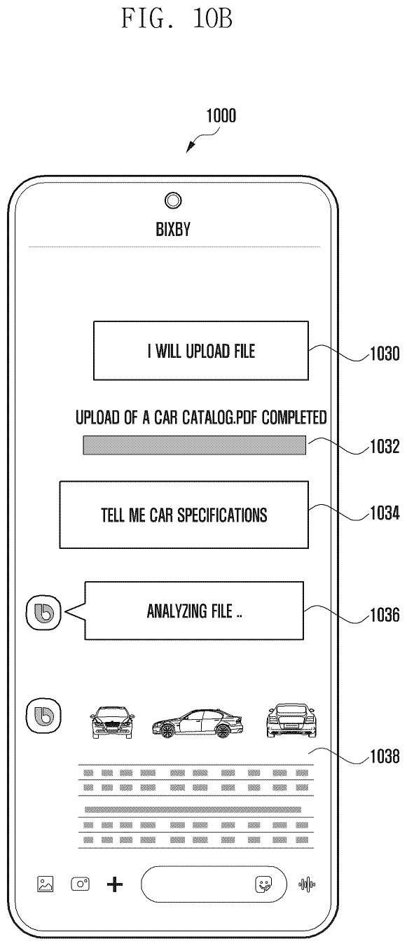

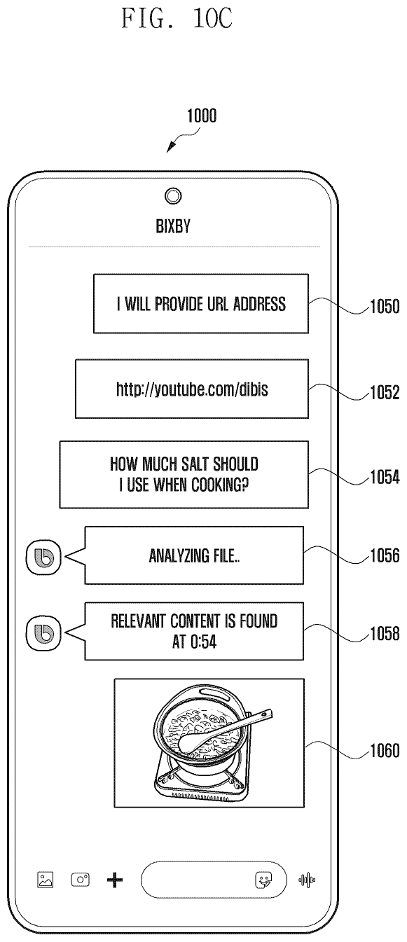

FIGS. 10A, 10B, and 10C illustrate a question and answer providing method of an electronic device according to various embodiments of the disclosure.

Referring to FIGS. 10A, 10B, and 10C, the electronic device may provide a voice assistant as a conversational UI.

According to an embodiment, depending on a timepoint at which the electronic device (or the external server) 1000 processes input data to be used for finding an answer to a query, the method may be classified into a method of utilizing pre-input data and a method of retrieving data that is input in real time. In addition, the method of acquiring data may be classified into a method of acquiring data through a search based on a user request and a method based on data directly provided by the user.

According to an embodiment, when a user selects input data to be used for a question-and-answer, such as a specific file, or selects a specific web page, the electronic device (or the external server) may, after the selection of the input data, analyze the input data and provide information required for the question-and-answer.

FIG. 10A illustrates a screen of a voice assistant provided on an electronic device in case that, after a user selects a specific file, the electronic device provides an answer corresponding to a user query within the selected file.

According to an embodiment, when the voice assistant function of the electronic device 1000 is activated, the electronic device 1000 may display a phrase 1010 requesting activation of the voice assistant and/or user utterance.

According to an embodiment, a user may input a phrase 1012 instructing the upload of a file as input data via voice utterance or keyboard input, and may upload the file (e.g., manual.pdf). In this case, the electronic device 1000 may display a display object 1014 and a phrase indicating that the file is being uploaded.

According to an embodiment, a user may input, via voice utterance or keyboard input, a query phrase 1016 (e.g., “The oil pressure warning light is on, what should I do?”).

According to an embodiment, the electronic device 1000 may analyze input data in response to a user query. For example, the electronic device 1000 may extract, from the uploaded file, an answer corresponding to the query, such as text including keywords included in the query (e.g., oil pressure warning light, warning light, light on), text recorded on a page including the text, and/or image information. In this case, the electronic device 1000 may display a phrase 1018 indicating that an answer is being generated.

According to an embodiment, the electronic device 1000 may provide the extracted answer through a voice assistant. For example, the electronic device 1000 may provide an answer 1020 in the form of text (e.g., if there is an engine oil leak, stop driving and refill the engine oil) on the conversational UI.

FIG. 10B illustrates a screen of a voice assistant provided on an electronic device in case that, after a user selects a specific file, the electronic device provides an answer corresponding to a user query within the selected file.

According to an embodiment, a user may input a phrase 1030 instructing the upload of a file as input data via voice utterance or keyboard input, and may upload the file (e.g., manual.pdf). In this case, the electronic device 1000 may display a display object 1032 and a phrase indicating that the file is being uploaded.

According to an embodiment, a user may input, via voice utterance or keyboard input, a query phrase 1034 (e.g., “Tell me the car specifications”).

According to an embodiment, the electronic device 1000 may analyze input data in response to a user query. For example, the electronic device 1000 may extract, from the uploaded file, an answer corresponding to the query, such as text including keywords included in the query (e.g., car, specifications), text recorded on a page including the text, and/or image information. In this case, the electronic device 1000 may display a phrase 1036 indicating that an answer is being generated.

According to an embodiment, the electronic device 1000 may provide the extracted answer through a voice assistant. For example, the electronic device 1000 may provide image content 1038 including a page corresponding to the user query on the conversational UI.

FIG. 10C illustrates a screen of a voice assistant provided on an electronic device in case that, after a user selects a specific URL, the electronic device provides an answer corresponding to a user query within a web page of the URL.

According to an embodiment, when a user directly selects input data, the user may select the input data via a URL without uploading a specific file.

According to an embodiment, a user may input a phrase 1050 indicating selection of a specific URL as input data via voice utterance or keyboard input, and may input the URL 1052. Here, the URL may be the address of a video streaming site.

According to an embodiment, a user may input a query phrase 1054 (e.g., “How much salt should I use when cooking?”) via voice utterance or keyboard input.

According to an embodiment, the electronic device 1000 may analyze input data in response to a user query. For example, the electronic device 1000 may access the URL, analyze text and/or images contained in the video through an OCR module, or extract text from audio information through an ASR module. The electronic device 1000 may display a phrase 1056 indicating that an answer is being generated.

According to an embodiment, the electronic device 1000 may identify a section of video content of the URL in which an answer corresponding to the user query can be identified, and may display a phrase 1058 indicating the section. In addition, the electronic device 1000 may display a captured screen 1060 of the section on a voice assistant.

According to an embodiment, when the user does not specify input data, the electronic device may identify a particular search engine or content provider that may serve as a trigger, based on other content input by the user, such as conversation content with another user, and may obtain data therefrom. In addition, when determining an external service from which to retrieve data, information preferred by the user may be reflected based on the user's history. In addition, when the user uploads a file, the electronic device may provide an answer corresponding to the user query, with respect to the indexed content after the upload, without requiring re-uploading.

An electronic device according to various embodiments of the disclosure may include memory and at least one processor operatively connected to the memory.

According to an embodiment, the memory may store instructions that are executable by at least one processor and, when executed, cause the electronic device to acquire at least one input data including a plurality of content items, and to determine a type of each of the plurality of content items included in the acquired input data.

According to an embodiment, the memory may store instructions that cause the electronic device to index the content items of each type, generate a candidate query corresponding to the content items, select at least one content item corresponding to the candidate query from among the plurality of content items and determine the selected at least one content item as a candidate answer, and store the candidate query and the candidate answer so that the candidate query and the candidate answer match with each other.

According to an embodiment, the electronic device may further include at least one input device.

According to an embodiment, the memory may store instructions that cause the electronic device to receive a user query through the input device, select a candidate query corresponding to the user query, and select at least one of candidate answers stored to match with the selected candidate query and provide the selected candidate answer to the user as an answer.

According to an embodiment, the electronic device may further include a display.

According to an embodiment, the memory may store instructions that cause the electronic device to provide the user query and the answer by using an interactive user interface (UI) displayed on the display.

According to an embodiment, the memory may store instructions that cause the electronic device to assign the same index as the candidate query to a content item determined as the candidate answer.

According to an embodiment, the type of the content item may include at least one of text, a table, an image, or audio.

According to an embodiment, the memory may store instructions that cause the electronic device to determine a plurality of queries from the received user query, determine a plurality of candidate answers respectively matched to the plurality of queries, and generate an answer to be provided to the user by combining the determined plurality of candidate answers.

According to an embodiment, the memory may store instructions that, in case that a first query and a second query are determined from the received user query, cause the electronic device to determine a first type of candidate answer corresponding to the first query and a second type of candidate answer corresponding to the second query.

According to an embodiment, the memory may store instructions that cause the electronic device to generate a new query by combining the plurality of queries and to assign an index to the generated new query.

According to an embodiment, the memory may store instructions that, when the at least one content item is selected and determined as a candidate answer, cause the electronic device to determine a ranking of the selected at least one content item.

According to an embodiment, the input data may be data stored in the memory or acquired from the outside through the communication module.

According to an embodiment, the memory may store instructions that, when determining the candidate answer corresponding to the candidate query, cause the electronic device to configure a higher weight for a content item included in the data stored in the memory.

According to an embodiment, the memory may store instructions that, in case that the input data is video or audio data, cause the electronic device to generate the candidate answer by using a time section within the input data.

According to an embodiment, the memory may store instructions that cause the electronic device to transmit a user utterance to an external server using the communication module and obtain an answer from the external server through the communication module.

A method for providing question-and-answer by an electronic device according to various embodiments of the disclosure may include acquiring at least one input data including a plurality of content items, determining a type of each of the plurality of content items included in the acquired input data, indexing the content items of each type, generating a candidate query corresponding to the content items, selecting, from among the plurality of content items, at least one content item corresponding to the candidate query and determining the selected at least one content item as a candidate answer, and storing the candidate query and the candidate answer so that the candidate query and the candidate answer match with each other.

According to an embodiment, the method may further include receiving a user query through an input device, selecting a candidate query corresponding to the user query, and selecting at least one of candidate answers stored to match with the selected candidate query and providing the selected candidate answer to the user as an answer.

According to an embodiment, the electronic device may provide the user query and the answer by using an interactive user interface (UI) displayed on the display.

According to an embodiment, the method may further include assigning the same index as the candidate query to a content item determined as the candidate answer.

According to an embodiment, the type of the content item may include at least one of text, a table, an image, or audio.

According to an embodiment, the method may include determining a plurality of queries from the received user query, determining a plurality of candidate answers respectively matched to the plurality of queries, and generating an answer to be provided to the user by combining the plurality of determined candidate answers.

According to an embodiment, the method may further include generating a new query by combining the plurality of queries and assigning an index to the generated new query.

According to an embodiment, the input data may be stored in memory of the electronic device or may be data obtained from outside the electronic device.

According to an embodiment, the method may further include, when determining the candidate answer corresponding to the candidate query, configuring a higher weight for a content item included in the data stored in the memory.

The electronic device according to various embodiments set forth herein may be one of various types of electronic devices. The electronic device may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that the embodiments and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. As used herein, each of such phrases as “A or B,” “at least one of A and B,” “at least one of A or B,” “A, B, or C,” “at least one of A, B, and C,” and “at least one of A, B, or C,” may include any one or all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used in various embodiments of the disclosure, the term “module” may include a unit implemented in hardware, software, or firmware, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in any other element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory storing instructions; and
at least one processor communicatively coupled to the memory,
wherein the instructions, when executed by the at least one processor individually or collectively, cause the electronic device to:
acquire input data including a plurality of content items,
determine a type of each of the plurality of content items included in the acquired input data,
index the plurality of content items of each type,
generate a candidate query corresponding to the plurality of content items,
select, from among the plurality of content items, at least one content item corresponding to the candidate query,
determine the selected at least one content item as a candidate answer,
match the candidate query and the candidate answer with each other, and
store the matched candidate query and candidate answer.

2. The electronic device of claim 1, further comprising:
at least one input device,
wherein the instructions, when executed by the at least one processor individually or collectively, further cause the electronic device to:
receive a user query through the at least one input device,
select a candidate query corresponding to the user query,
select at least one stored candidate answer matched with the selected candidate query, and
provide the selected at least one stored candidate answer to a user as an answer.

3. The electronic device of claim 2, further comprising:
a display,
wherein the instructions, when executed by the at least one processor individually or collectively, further cause the electronic device to:
provide the user query and the answer via an interactive user interface (UI) displayed on the display.

4. The electronic device of claim 1, wherein the instructions, when executed by the at least one processor individually or collectively, further cause the electronic device to:
assign a same index as the candidate query to the content item determined as the candidate answer.

5. The electronic device of claim 2, wherein the instructions, when executed by the at least one processor individually or collectively, further cause the electronic device to:
determine a plurality of queries from the received user query,
determine a plurality of candidate answers matched with the plurality of queries respectively, and
generate an answer to be provided to the user by combining the determined plurality of candidate answers.

6. The electronic device of claim 5, wherein the instructions, when executed by the at least one processor individually or collectively, further cause the electronic device to:
in case that a first query and a second query are determined from the received user query, determine a first type of candidate answer corresponding to the first query and a second type of candidate answer corresponding to the second query.

7. The electronic device of claim 5, wherein the instructions, when executed by the at least one processor individually or collectively, further cause the electronic device to:
generate a new query by combining the plurality of queries, and assign an index to the generated new query.

8. The electronic device of claim 1, wherein the instructions, when executed by the at least one processor individually or collectively, further cause the electronic device to:
in case that the at least one content item is selected and determined as a candidate answer, determine a ranking of the selected at least one content item.

9. The electronic device of claim 1, further comprising:
a communication module,
wherein the input data is data stored in the memory or data acquired from outside through the communication module, and
wherein the instructions, when executed by the at least one processor individually or collectively, further cause the electronic device to:
in case that the candidate answer corresponding to the candidate query is determined, configure a higher weight for a content item included in the data stored in the memory.

10. The electronic device of claim 1, wherein the instructions, when executed by the at least one processor individually or collectively, further cause the electronic device to:
in case that the input data is video or audio data, generate the candidate answer by using a time section within the input data.

11. A method for providing a question-and-answer performed by an electronic device, the method comprising:
acquiring input data including a plurality of content items;
determining a type of each of the plurality of content items included in the acquired input data;
indexing the plurality of content items of each type;
generating a candidate query corresponding to the plurality of content items;
selecting, from among the plurality of content items, at least one content item corresponding to the candidate query;
determining the selected at least one content item as a candidate answer;
matching the candidate query and the candidate answer with each other; and
storing the matched candidate query and candidate answer.

12. The method of claim 11, further comprising:
receiving a user query through at least one input device of the electronic device;
selecting a candidate query corresponding to the user query;
selecting at least one stored candidate answer matched with the selected candidate query; and
providing the selected at least one stored candidate answer to a user as an answer.

13. The method of claim 12, further comprising:
providing the user query and the answer via an interactive user interface (UI) displayed on a display of the electronic device.

14. The method of claim 11, further comprising:
assigning a same index as the candidate query to the content item determined as the candidate answer.

15. The method of claim 12, further comprising:
determining a plurality of queries from the received user query;
determining a plurality of candidate answers matched with the plurality of queries respectively; and
generating an answer to be provided to the user by combining the determined plurality of candidate answers.

16. The method of claim 15, further comprising:
in case that a first query and a second query are determined from the received user query, determining a first type of candidate answer corresponding to the first query and a second type of candidate answer corresponding to the second query.

17. The method of claim 15, further comprising:
generating a new query by combining the plurality of queries; and
assigning an index to the generated new query.

18. The method of claim 11, further comprising:
in case that the at least one content item is selected and determined as a candidate answer, determining a ranking of the selected at least one content item.

19. One or more non-transitory computer-readable storage media storing one or more computer programs including computer-executable instructions that, when executed by at least one processor of an electronic device individually or collectively, cause the electronic device to perform operations, the operations comprising:
acquiring input data including a plurality of content items;
determining a type of each of the plurality of content items included in the acquired input data;
indexing the plurality of content items of each type;
generating a candidate query corresponding to the plurality of content items;
selecting, from among the plurality of content items, at least one content item corresponding to the candidate query;
determining the selected at least one content item as a candidate answer;
matching the candidate query and the candidate answer with each other; and
storing the matched candidate query and candidate answer.

20. The one or more non-transitory computer-readable storage media of claim 19, the operations further comprising:
receiving a user query through at least one input device of the electronic device;
selecting a candidate query corresponding to the user query;
selecting at least one stored candidate answer matched with the selected candidate query; and
providing the selected at least one stored candidate answer to a user as an answer.
